(19) United States
(12) Patent Application Publication
(10) Pub. No.: US 2025/0079746 A1
(43) Pub. Date: Mar. 6, 2025

(54) CONNECTOR ASSEMBLY

(71) Applicant: Japan Aviation Electronics Industry, Ltd., Tokyo (JP)

(72) Inventors: Taiki HANEISHI, Tokyo (JP); Takashi OMODACHI, Tokyo (JP)

(21) Appl. No.: 18/810,171

(22) Filed: Aug. 20, 2024

(30) Foreign Application Priority Data
Aug. 31, 2023 (JP) 2023-141411

(51) Int. Cl. H01R 13/502; H01R 12/71

(52) U.S. Cl. CPC H01R 13/502; H01R 12/716

(57) ABSTRACT

Provided is a technique for improving the mechanical strength of a connector assembly. A connector assembly according to the present disclosure includes a plug connector including a plurality of plug contacts, a plug housing that holds the plurality of plug contacts, and a plug hold-down mounted on the outside of the plurality of plug contacts in the plug housing, and a receptacle connector including a plurality of receptacle contacts and a receptacle housing that holds the plurality of receptacle contacts. Each of the plug contacts and each of the receptacle contacts come into electrical contact by mating the plug connector and the receptacle connector with each other in a mating direction.

### INCORPORATION BY REFERENCE

This application is based upon and claims the benefit of priority from Japanese patent application No. 2023-141411, filed on Aug. 31, 2023, the disclosure of which is incorporated herein in its entirety by reference.

### BACKGROUND

The present disclosure relates to a connector assembly.

As shown in FIG. 10 of the present application, Patent Literature 1 (Japanese Unexamined Patent Application Publication No. 2015-185541) discloses a plug hold-down 960 of a plug connector in a connector assembly. The plug hold-down 960 includes a top part 961, side parts 962 and 963, an end part 964, and carrier cutting planes 965 and 966. The carrier cutting planes 965 and 966 are on the outside (in the positive direction of the y-axis in this example) of the plug connector in the top part 961. In other words, the carrier cutting planes 965 and 966 are on the outside (in the positive direction of the y-axis in this example) of a plug housing in the pitch direction in the plug hold-down 960.

An example of a method of manufacturing the plug hold-down 960 is described hereinafter. A plate member made of metal is punched to form a punched body. Further, the punched body is bent to form a plug hold-down 900 with a carrier shown in FIG. 11. FIG. 11 is a perspective view of a plug hold-down with a carrier. As shown in FIG. 11, the plug hold-down 900 with a carrier includes a carrier 910 and a plurality of plug hold-downs 960. In this embodiment, the plurality of plug hold-downs 960 are three plug hold-downs 960. In the plug hold-down 900 with a carrier, each plug hold-down 960 is mechanically connected to the carrier 910 through cutting parts 968 and 969. As shown in FIGS. 10 and 11, each plug hold-down 960 is a plate-shaped body where the top part 961, the side parts 962 and 963, and the end part 964 link together, and an end surface of this plate-shaped body is a punched surface. Finally, the cutting parts 968 and 969 are cut to separate the plurality of plug hold-downs 960 from the carrier 910. Each of the separated plug hold-downs 960 have the carrier cutting planes 965 and 966 shown in FIG. 10. The carrier cutting planes 965 and 966 are formed as a result of cutting the cutting parts 968 and 969.

### SUMMARY

In this connector assembly, the plug hold-down 960 is mounted on a plug housing of a plug connector. Further, the carrier cutting planes 965 and 966 are on the outside of the plug housing in the pitch direction in the plug hold-down 960. The shape of the plug hold-down 960 is restricted by the carrier cutting planes 965 and 966. Thus, the plug hold-down 960 is unable to cover a part of the plug housing of the plug connector that is disposed near the carrier cutting planes 965 and 966. Therefore, in such a connector assembly, there is a scope for studies in the shape of a plug hold-down in terms of mechanical strength of the connector assembly.

An object of the present disclosure is to provide a technique for improving the mechanical strength of a connector assembly.

According to a first aspect of the present disclosure, there is provided a connector assembly including a plug connector including a plurality of plug contacts, a plug housing that holds the plurality of plug contacts, and a plug hold-down mounted on outside of the plurality of plug contacts in the plug housing, and a receptacle connector including a plurality of receptacle contacts and a receptacle housing that holds the plurality of receptacle contacts, wherein each of the plug contacts and each of the receptacle contacts come into electrical contact by mating the plug connector and the receptacle connector with each other in a mating direction, the plurality of plug contacts are arranged in a pitch direction, the plug housing includes two side walls extending in parallel with the pitch direction and an end wall connecting ends of the two side walls, the end wall includes a peripheral surface bordering outside of the plug housing, an opposed surface opposed to the receptacle housing when the plug connector and the receptacle connector mate with each other, and a corner part at an intersection between the peripheral surface and the opposed surface, the plug hold-down includes a corner drawn part and a carrier cutting plane, the carrier cutting plane is formed on a side of the plug hold-down facing the plurality of plug contacts, and the corner drawn part covers the corner part.

According to the present disclosure, the mechanical strength of a connector assembly is improved.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a receptacle connector and a plug connector that are electrically disconnected;

FIG. 2 is an exploded perspective view of the receptacle connector;

FIG. 3 is an exploded perspective view of the plug connector;

FIG. 4 is a perspective view of a plug hold-down;

FIG. 5 is a plan view of the plug hold-down;

FIG. 6 is a side view of the plug hold-down;

FIG. 7 is a front view of the plug hold-down;

FIG. 8 is a perspective view of the plug hold-down viewed from the opposite side from FIG. 3;

FIG. 9 is a perspective view of a plug hold-down with a carrier;

FIG. 10 is a view showing FIG. 6E of Patent Literature 1; and

FIG. 11 is a perspective view of a plug hold-down with a carrier.

### DESCRIPTION OF EMBODIMENTS

A specific embodiment of the present disclosure will be described hereinafter in detail with reference to the drawings. The present disclosure, however, is not limited to the below-descried embodiments. The following description and the drawings are appropriately shortened and simplified to clarify the explanation.

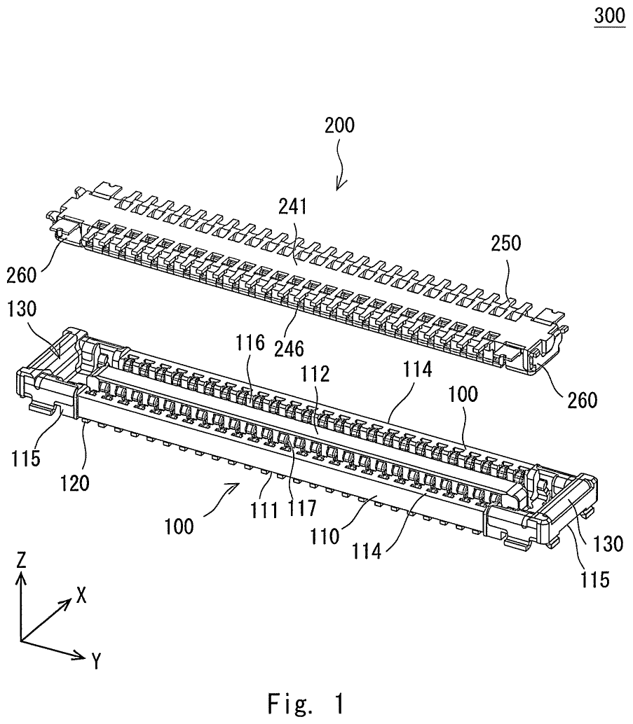

Note that the right-handed xyz coordinate system in FIG. 1 and other figures is shown for the purpose of illustrating the positional relationship of the components, and should not be interpreted as limiting the position of a receptacle connector 100, a plug connector 200 and the like when they are actually used. Generally, the x-axis direction is a width direction, the y-axis direction is a pitch direction, the z-axis direction is a mating direction in which the receptacle connector 100 and the plug connector 200 mate with each other as described later, and the xy plane is a horizontal plane, which are common among the figures.

### Embodiment

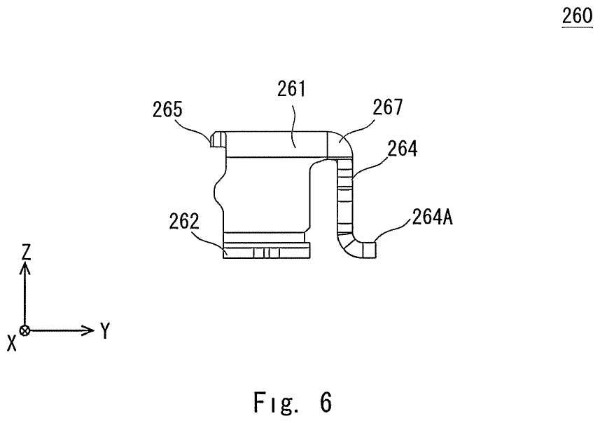

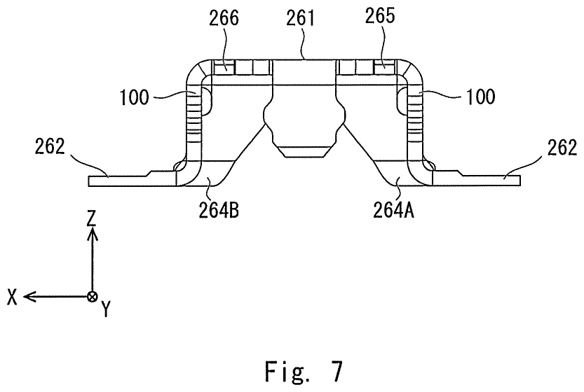

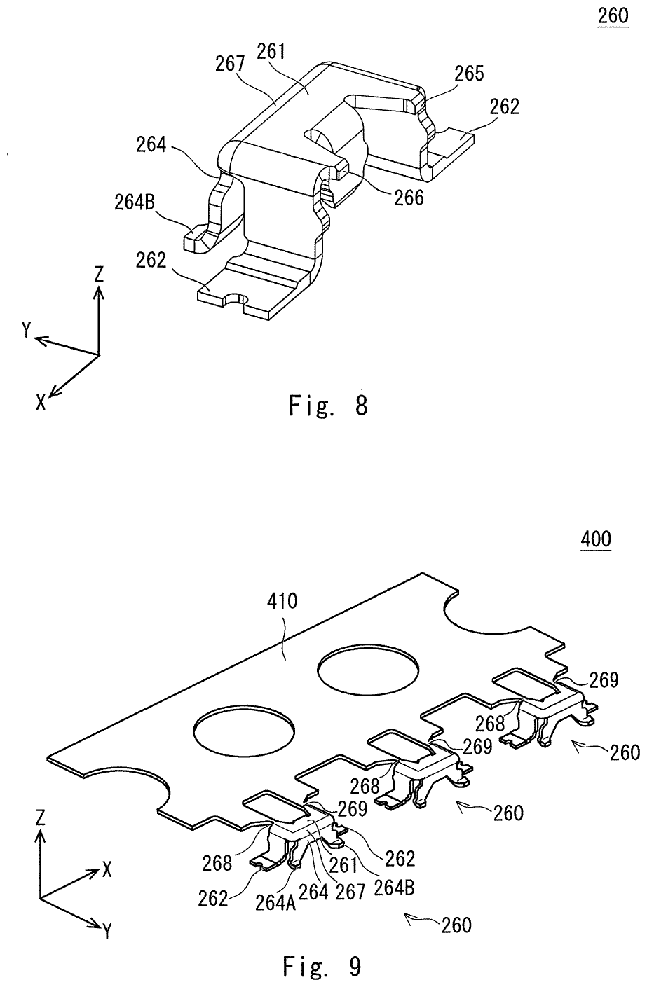

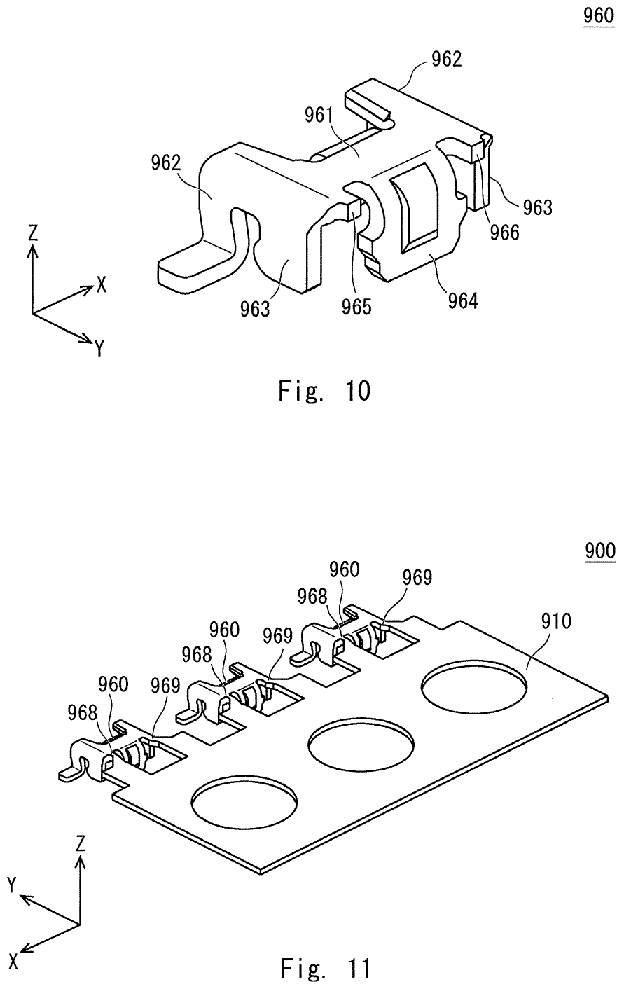

An embodiment of the present disclosure will be described hereinafter with reference to FIGS. 1 to 9.

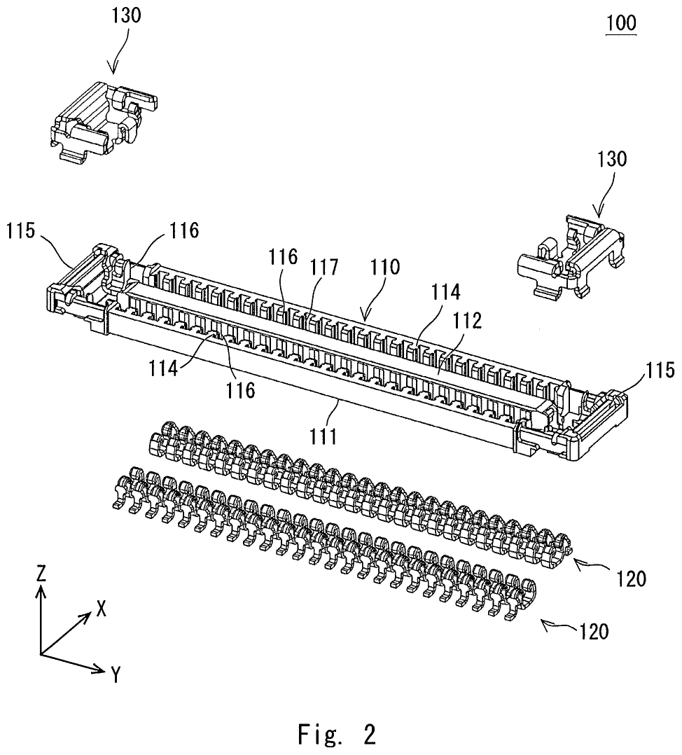

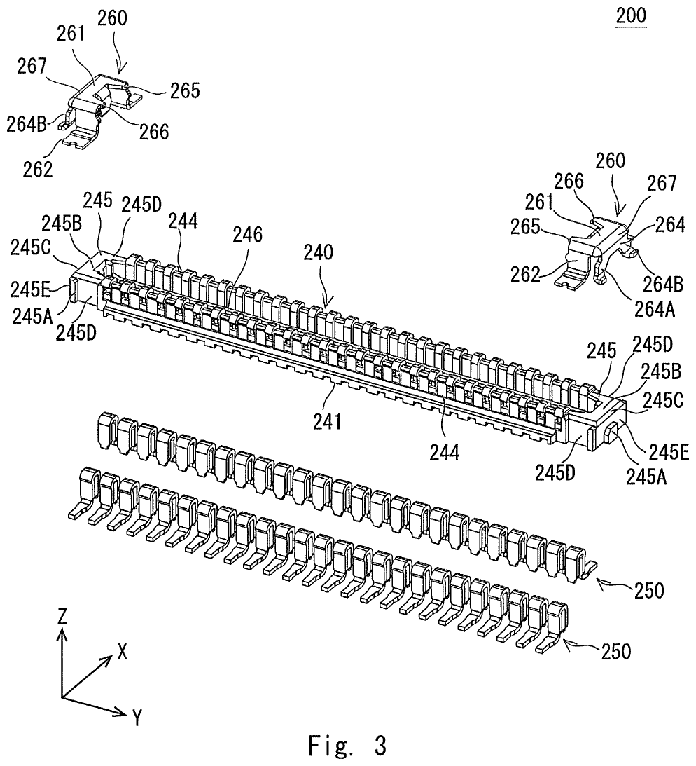

As shown in FIG. 1, a connector assembly 300 includes the receptacle connector 100 and the plug connector 200. The receptacle connector 100 shown in FIGS. 1 and 2 is disposed in such a way that a receiving space 116 faces upward (in the positive direction of the z-axis in this example). The plug connector 200 shown in FIG. 1 is disposed in such a way that a receiving space 246 faces downward (in the negative direction of the z-axis in this example). FIG. 3 is an exploded perspective view of the plug connector shown in FIG. 1. The plug connector 200 shown in FIG. 3 is disposed in such a way that the receiving space 246 faces upward, which is different from the plug connector 200 shown in FIG. 1.

The receptacle connector 100 includes a plurality of receptacle contacts 120 and a receptacle housing 110.

The receptacle housing 110 holds the plurality of receptacle contacts 120.

As shown in FIGS. 1 and 3, the plug connector 200 includes a plurality of plug contacts 250, a plug housing 240, and a plug hold-down 260. The plug housing 240 holds the plurality of plug contacts 250. The plug hold-down 260 is mounted on the outside of the plurality of plug contacts 250 in the plug housing 240.

The receptacle connector 100 and the plug connector 200 according to this embodiment can be mounted on different circuit boards from each other. The receptacle connector 100 and the plug connector 200 may be used as surface mounting devices, and they may be respectively mounted on printed circuit boards by soldering, for example. The receptacle connector 100 and the plug connector 200 can be used as connectors for a circuit board. The plug connector 200 and the receptacle connector 100 mate with each other in a mating direction (in the z-axis direction in this example), and thereby each plug contact 250 comes into electrical contact with each receptacle contact 120. The different circuit boards are thereby electrically connected.

A detailed structure of the connector assembly 300 is described hereinafter.

As shown in FIGS. 1 and 2, the receptacle housing 110 has a substantially rectangular parallelepiped shape, for example. The receptacle housing 110 is formed using an electrical insulating material, for example. The electrical insulating material is a resin material or the like, for example. As shown in FIG. 2, the receptacle housing 110 includes a bottom part 111, an island part 112, two side walls 114, and an end wall 115. The bottom part 111 is preferably a plate-shaped part extending in a pitch direction (in the y-axis direction in this example). The island part 112 projects upward (in the positive direction of the z-axis in this example) from the bottom part 111 and extends in the pitch direction (in the y-axis direction in this example). The two side walls 114 project upward from the bottom part 111 and extend in the pitch direction. The two side walls 114 are disposed parallel to each other, and the island part 112 is disposed between the two side walls 114. The end wall 115 connects the ends of the two side walls 114. The end wall 115 and the island part 112 are preferably separated from each other. The receptacle housing 110 may have two end walls 115. The two end walls 115 connect the ends of the two different side walls 114, respectively. The two side walls 114 and the two end walls 115 preferably surround the island part 112. The receiving space 116 is formed between the two side walls 114, the two end walls 115, and the island part 112. The receiving space 116 is a frame-shaped body that surrounds the island part 112. The receiving space 116 has a size that is large enough to accommodate a part of the plug connector 200, such as a side wall 244 and an end wall 245, for example, when the plug connector 200 and the receptacle connector 100 mate with each other.

The plurality of receptacle contacts 120 are arranged in the pitch direction (in the y-axis direction in this example) in the receptacle housing 110. The pitch direction is the same as the longitudinal direction of the receptacle housing 110. The plurality of receptacle contacts 120 shown in FIG. 2 are arranged in two rows along the pitch direction. The side walls 114 preferably have a plurality of contact holding grooves 117. Each receptacle contact 120 may be disposed at each contact holding groove 117, so that the receptacle housing 110 holds the plurality of receptacle contacts 120. The contact holding grooves 117 are preferably equally spaced in the pitch direction. Each of the two side walls 114 preferably has the plurality of contact holding grooves 117. Each receptacle contact 120 is preferably axisymmetric with respect to a line extending in the longitudinal direction of the island part 112 as a center line. Each contact holding groove 117 preferably extends continuously from the side surface of the island part 112, the top surface of the bottom part 111, to the internal surface of the side wall 114. The internal surface of the side wall 114 is opposed to the side surface of the island part 112.

The receptacle connector 100 preferably further includes a receptacle hold-down 130. The receptacle hold-down 130 is mounted on the outside of the plurality of receptacle contacts 120 in the receptacle housing 110. To be specific, the receptacle hold-down 130 is mounted by integral molding or press-fitting into a part of the two side walls 114 and the end wall 115. The receptacle hold-down 130 reinforces the receptacle housing 110. A plate member made of metal is punched to form a punched body. Further, the punched body may bent, for example, to form the receptacle hold-down 130. The receptacle hold-down 130 can be used as a terminal that is electrically connectable to a power supply or the like of a circuit board, which is not shown. If the receptacle hold-down 130 and the plug hold-down 260 are able to mate with each other, the plug connector 200 and the receptacle connector 100 can mate smoothly. In other words, the receptacle hold-down 130 can be used for electrical connection or mating between the plug connector 200 and the receptacle connector 100.

As shown in FIGS. 1 and 3, the plug housing 240 has a substantially rectangular parallelepiped shape, for example. The plug housing 240 is formed using an electrical insulating material, for example. The electrical insulating material is a resin material or the like, for example. As shown in FIG. 3, the plug housing 240 includes a bottom part 241, two side walls 244, and an end wall 245.

The bottom part 241 is preferably a plate-shaped part extending in the pitch direction (in the y-axis direction in this example). The two side walls 244 project upward from the bottom part 241 and extend in the pitch direction. The two side walls 244 are disposed parallel to each other. The end wall 245 connects the ends of the two side walls 244.

The end wall 245 includes a peripheral surface 245A, an opposed surface 245B, and a corner part 245C. The peripheral surface 245A borders the outside of the plug housing 240. The opposed surface 245B is opposed to the receptacle housing 110 when the plug connector 200 and the receptacle connector 100 mate with each other. The opposed surface 245B shown in FIG. 3 faces upward (in the positive direction of the z-axis in this example). The corner part 245C is at the intersection between the peripheral surface 245A and the opposed surface 245B. The peripheral surface 245A has a peripheral side surface 245D and a peripheral end surface 245E. The peripheral side surface 245D is continuous with the plane of the side wall 244. The peripheral end surface 245E intersects with the peripheral side surface 245D. The peripheral side surface 245D faces the width direction (in the x-axis direction in this example), and the peripheral end surface 245E faces the pitch direction (in the y-axis direction in this example).

The plug housing 240 may have two end walls 245. The two end walls 245 connect the ends of the two different side walls 244, respectively. The two side walls 244 and the two end walls 245 are preferably frame-shaped bodies. The receiving space 246 is formed between the two side walls 244 and the two end walls 245. The receiving space 246 has a substantially rectangular parallelepiped shape. The receiving space 246 has a size that is large enough to accommodate a part of the receptacle connector 100, such as the island part 112 shown in FIG. 1, for example, when the plug connector 200 and the receptacle connector 100 (see FIG. 1) mate with each other.

The plurality of plug contacts 250 are arranged in the pitch direction (in the y-axis direction in this example) in the plug housing 240. The pitch direction is the same as the longitudinal direction of the plug housing 240. The plurality of plug contacts 250 shown in FIG. 2 are arranged in two rows along the pitch direction. A plate member made of metal is punched to form a strip-shaped piece. Further, the strip-shaped piece may be bent, for example, to manufacture the plug contact 250. Each plug contact 250 may be integrally molded or press-fit between the two side walls 244, so that the plug housing 240 holds the plurality of plug contacts 250. The plurality of plug contacts 250 are preferably equally spaced in the pitch direction in the plug housing 240.

The plug connector 200 further includes the plug hold-down 260. The plug hold-down 260 is mounted on the outside of the plurality of plug contacts 250 in the plug housing 240. To be specific, the plug hold-down 260 is mounted by press-fit into a part of the two side walls 244 and the end wall 245. The plug hold-down 260 thereby reinforces the plug housing 240. One plate-shaped body made of metal is punched to form a punched body. Further, the punched body may be bent, for example, to form the plug hold-down 260. The plug hold-down 260 can be used as a terminal that is electrically connectable to a power supply or the like of a circuit board, which is not shown.

As shown in FIGS. 3 to 7, the plug hold-down 260 includes a top part 261, a side part 262, an end part 264, a first connection part 264A, a second connection part 264B, and a corner drawn part 267. The top part 261, the side part 262, the end part 264, the first connection part 264A, the second connection part 264B, and the corner drawn part 267 are preferably made from one plate. The plug hold-down 260 may include two side parts 262.

The top part 261 covers the opposed surface 245B of the end wall 245. The corner drawn part 267 is formed at the outer edge of the top part 261 and covers the corner part 245C. The side part 262 extends from an end of the top part 261 in the width direction and covers the peripheral side surface 245D. The end part 264 extends from an end of the top part 261 in the pitch direction and covers the peripheral end surface 245E.

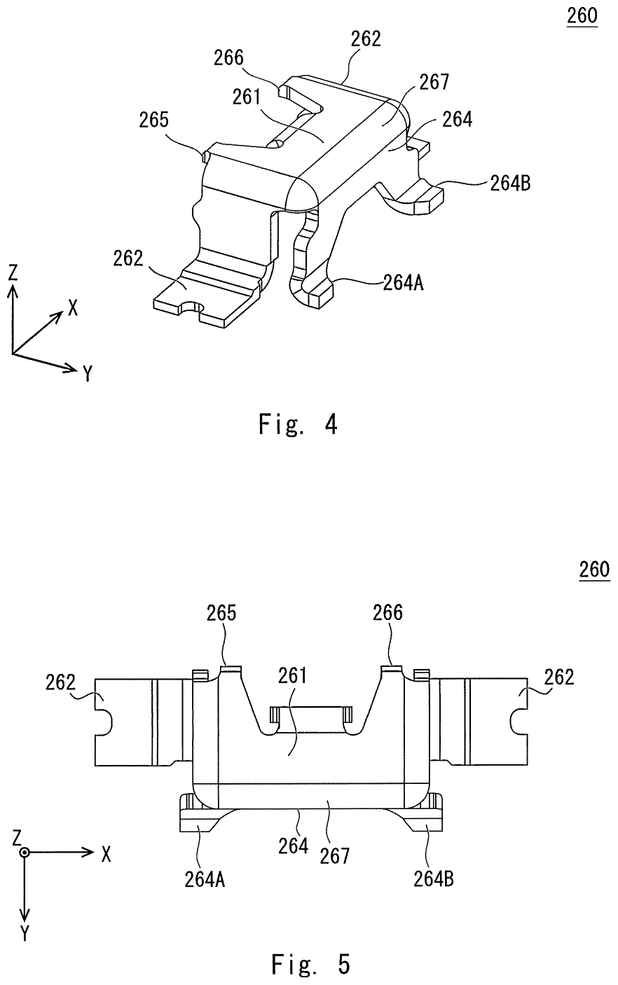

The end part 264 preferably further includes the first connection part 264A and the second connection part 264B. The first connection part 264A and the second connection part 264B are electrically connectable to a terminal of a board on which the plug connector 200 is mounted. As shown in FIG. 4, the first connection part 264A and the second connection part 264B branch off from the corner drawn part 267 in the width direction (in the x-axis direction in this example) and extend to the board side (in the negative direction of the z-axis in this example). The first connection part 264A and the second connection part 264B have a tapered shape that is tapered with respect to the mating direction (the z-axis direction in this example) when viewed from the outside (the y-axis direction in this example) of the plug housing 240.

As shown in FIG. 3, carrier cutting planes 265 and 266 are formed on the plurality of plug contacts 250 side of the plug hold-down 260. To be specific, as shown in FIG. 4, the carrier cutting planes 265 and 266 are formed on the inside of the plug housing 240 in the pitch direction in the top part 261.

An example of a method of manufacturing the plug hold-down 260 is described hereinafter.

First, a plate member made of metal is punched to form a punched body.

Next, the punched body is bent to form a plug hold-down 400 with a carrier shown in FIG. 9. FIG. 9 is a perspective view of a plug hold-down with a carrier. The plug hold-down 400 with a carrier includes a carrier 410 and a plurality of plug hold-downs 260. Although the plug hold-down 400 with a carrier includes three plug hold-downs 260 in this embodiment, it may include one, two, or four or more plug hold-downs 260. In the plug hold-down 400 with a carrier, each plug hold-down 260 is mechanically connected to the carrier 410 through cutting parts 268 and 269. Each plug hold-down 260 is a plate-shaped body where the top part 261, the side part 262, the end part 264, and the corner drawn part 267 link together, and the end surface of this plate-shaped body is a punched surface.

Finally, the cutting parts 268 and 269 are cut to separate the plurality of plug hold-downs 260 from the carrier 410. Each of the separated plug hold-downs 260 has the carrier cutting planes 265 and 266 shown in FIGS. 3 to 8. The carrier cutting planes 265 and 266 are formed as a result of cutting the cutting parts 268 and 269. The plug hold-down 260 is thereby manufactured.

In the above-described structure of the connector assembly 300, the carrier cutting planes 265 and 266 are formed on the plurality of plug contacts 250 side of the plug hold-down 260. Therefore, there is no need to form the carrier cutting planes on the opposite side of the plurality of plug contacts 250 in the plug hold-down 260, which is, on the outside of the plug housing 240 in the pitch direction in the plug hold-down 260. This allows the corner drawn part 267 to be formed on the outside of the plug connector 200 in the pitch direction in the plug hold-down 260. This also improves the press workability in the corner drawn part 267. Further, the corner drawn part 267 is bent, which enhances the mechanical strength of the plug hold-down 260. Furthermore, the corner drawn part 267 covers the corner part 245C of the end wall 245 and thereby reinforces the end wall 245. This improves the mechanical strength of the plug connector 200. The corner drawn part 267 has a curved surface, which enhances the guiding capability of the plug connector 200. To be specific, the surface of the corner drawn part 267 is in the form of a circular curve and connects the top part 261 and the end part 264. This easily guides the plug connector 200 to the receptacle connector 100 when mating the receptacle connector 100 with the plug connector 200.

Further, the first connection part 264A and the second connection part 264B branch off from the corner drawn part 267 in the width direction orthogonal to the pitch direction and the mating direction and extend to the board side. The first connection part 264A and the second connection part 264B have a tapered shape that is tapered with respect to the mating direction when viewed from the outside of the plug housing 240. This allows the first connection part 264A and the second connection part 264B to be tightly soldered to terminals of a board, which are not shown, respectively. This improves the mounting strength of the first connection part 264A and the second connection part 264B.

The plug connector and the receptacle connector according to the present disclosure are applicable to use as a connector mounted on various electronic equipment. For example, the plug connector and the receptacle connector according to the present disclosure are available for connection of a board such as a printed circuit board or FPC (flexible printed circuit), for example.

Note that the present disclosure is not limited to the above-described embodiments and can be modified as appropriate without departing from the spirit and scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising:
a plug connector including a plurality of plug contacts, a plug housing that holds the plurality of plug contacts, and a plug hold-down mounted on outside of the plurality of plug contacts in the plug housing; and
a receptacle connector including a plurality of receptacle contacts and a receptacle housing that holds the plurality of receptacle contacts, wherein
each of the plug contacts and each of the receptacle contacts come into electrical contact by mating the plug connector and the receptacle connector with each other in a mating direction,
the plurality of plug contacts are arranged in a pitch direction,
the plug housing includes two side walls extending in parallel with the pitch direction and an end wall connecting ends of the two side walls,
the end wall includes a peripheral surface bordering outside of the plug housing, an opposed surface opposed to the receptacle housing when the plug connector and the receptacle connector mate with each other, and a corner part at an intersection between the peripheral surface and the opposed surface,
the plug hold-down includes a corner drawn part and a carrier cutting plane,
the carrier cutting plane is formed on a side of the plug hold-down facing the plurality of plug contacts, and
the corner drawn part covers the corner part.

2. The connector assembly according to claim 1, wherein
the peripheral surface of the end wall includes a peripheral end surface facing outside of the plug housing in the pitch direction,
the plug hold-down further includes an end part covering the peripheral end surface,
the end part includes a first connection part and a second connection part electrically connectable to a terminal of a board on which the plug connector is mounted,
the first connection part and the second connection part branch off from the corner drawn part in a width direction orthogonal to the pitch direction and the mating direction and extend to the board side, and
the first connection part and the second connection part have a tapered shape tapered with respect to the mating direction when viewed from the outside of the plug housing in the pitch direction.
